(19) United States
(12) Patent Application Publication
(10) Pub. No.: US 2026/0023784 A1
(43) Pub. Date: Jan. 22, 2026

(54) GENERATION APPARATUS, GENERATION METHOD, AND NON-TRANSITORY COMPUTER-READABLE RECORDING MEDIUM

(71) Applicant: LY Corporation, Tokyo (JP)

(72) Inventor: Masajirou IWASAKI, Tokyo (JP)

(21) Appl. No.: 19/198,573

(22) Filed: May 5, 2025

(30) Foreign Application Priority Data
Jul. 16, 2024 (JP) 2024-113599

(51) Int. Cl. G06F 16/901

(52) U.S. Cl. CPC G06F 16/9024

(57) ABSTRACT

A generation apparatus acquires a target graph, being a graph in which a plurality of nodes corresponding to a plurality of objects to be a target of data search is linked by edges, extracts output edges of a first number from among output edges having each node as a start point, targeted for each of the plurality of nodes included in the target graph, and then generates a first graph in which the plurality of nodes is linked by an edge obtained by inverting the direction of the extracted output edge, and output edges of a second number from among output edges having each node as a start point, targeted for each of the plurality of nodes included in the first graph, and then generates a second graph in which the plurality of nodes is linked by an edge obtained by inverting the direction of the extracted output edge.

### CROSS-REFERENCE TO RELATED APPLICATIONS

The present application claims priority to and incorporates by reference the entire contents of Japanese Patent Application No. 2024-113599 filed in Japan on Jul. 16, 2024.

### BACKGROUND OF THE INVENTION

### 1. Field of the Invention

The present invention relates to a generation apparatus, a generation method, and a non-transitory computer-readable recording medium.

### 2. Description of the Related Art

There are conventionally provided techniques of searching for various types of information. For example, there is provided a technique of performing a search using graph data (hereinafter also simply denoted as a “graph”) generated by a directed edge. Furthermore, such a technology is used for image search, for example. In information search using such a graph, there is provided a technique of generating a graph enabling an efficient search by updating the graph.

Patent Literature 1: JP 6959164 B

The above-described techniques, however, have room for improvement. For example, the above-described conventional technique performs update of the graph using a transpose graph obtained by performing one session of inversion of the direction of a directed edge of the existing graph. By performing one session of inversion in this manner, the number of input edges to be input to each node can be controlled. However, the number of output edges output from each node may vary, leading to an occurrence of a failure in generating an appropriate graph. In this manner, there is room for improvement in the conventional technique, and there is a demand for generating an appropriate graph while using information of an existing graph.

### SUMMARY OF THE INVENTION

According to one aspect of an embodiment, a generation apparatus includes an acquisition unit that acquires a target graph, being a graph in which a plurality of nodes is linked by edges, the plurality of nodes being nodes corresponding to a plurality of objects being targets of data search; a first generation unit that extracts output edges of a first number from among output edges having each of the nodes as a start point, targeted for each of the plurality of nodes included in the target graph, and then generates a first graph in which the plurality of nodes is linked by an edge obtained by inverting a direction of the extracted output edge; and a second generation unit that extracts output edges of a second number from among output edges having each of the nodes as a start point, targeted for each of the plurality of nodes included in the first graph, and then generates a second graph in which the plurality of nodes is linked by an edge obtained by inverting a direction of the extracted output edge.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of generation processing according to an embodiment;

FIG. 2 is a diagram illustrating a configuration example of a generation system according to the embodiment;

FIG. 3 is a diagram illustrating a configuration example of a generation apparatus according to the embodiment;

FIG. 4 is a diagram illustrating an example of an object information storage unit according to the embodiment;

FIG. 5 is a diagram illustrating an example of a target graph data storage unit according to the embodiment;

FIG. 6 is a diagram illustrating an example of a first graph data storage unit according to the embodiment;

FIG. 7 is a diagram illustrating an example of a second graph data storage unit according to the embodiment;

FIG. 8 is a flowchart illustrating an example of generation processing according to the embodiment;

FIG. 9 is a flowchart illustrating an example of search processing using graph data; and

FIG. 10 is a hardware configuration diagram illustrating an example of a computer that implements functions of the generation apparatus.

### DETAILED DESCRIPTION OF THE PREFERRED EMBODIMENTS

Hereinafter, modes (hereinafter referred to as “embodiment”) for implementing a generation apparatus, a generation method, and a non-transitory computer-readable recording medium having stored therein an information processing program according to the present application will be described in detail with reference to the drawings. Note that the generation apparatus, the generation method, and the generation program according to the present application are not limited by the embodiment. In the following embodiments, same parts are denoted by same reference numerals, and redundant description will be omitted.

### Embodiment

### 1. Generation Processing

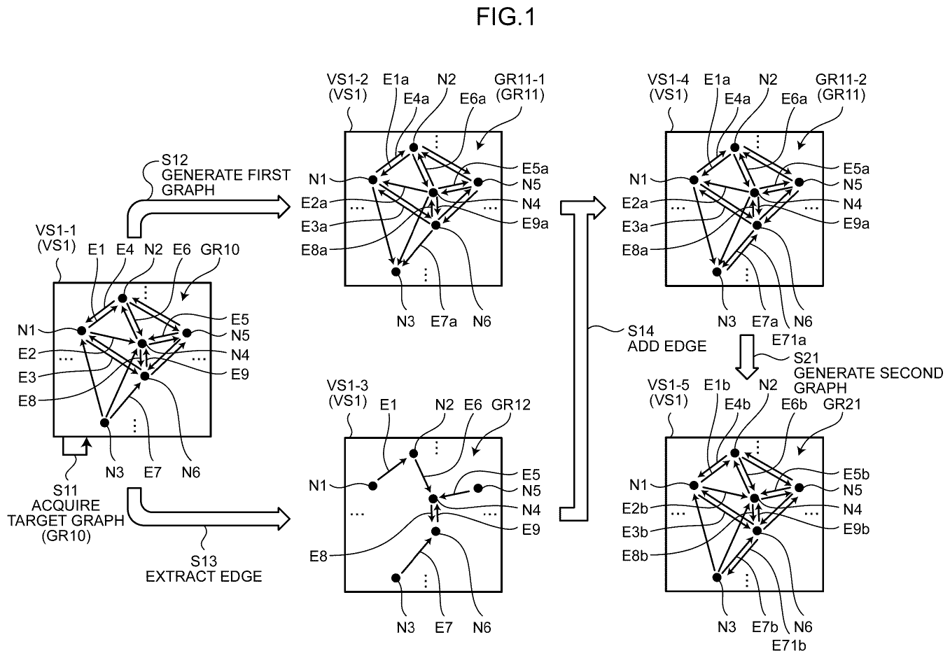

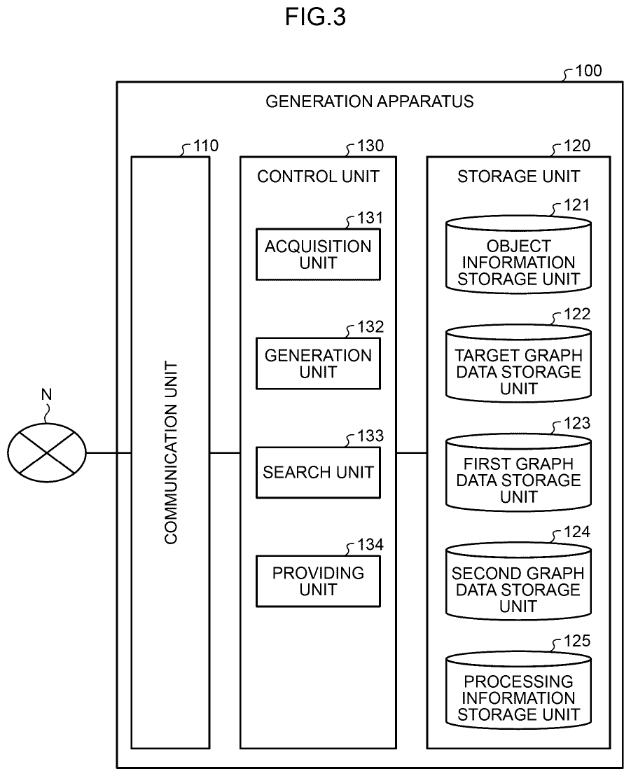

An example of generation processing according to an embodiment will be described with reference to FIG. 1. FIG. 1 is a diagram illustrating an example of generation processing according to the embodiment. In FIG. 1, a generation apparatus 100 (refer to FIG. 3) executes two sessions of processing of transposing an edge (also referred to as “2-session edge transposition processing”) based on target graph data being graph data as a processing target, and generates graph data. Hereinafter, graph data subjected to one session of edge transposition processing, that is, the graph data generated by performing one session of edge transposition processing may be denoted as first graph data, while graph data subjected to execution of two session of edge transposition processing (2-session edge transposition processing), that is, the graph data generated by performing one more session of edge transposition processing (two sessions in total) may be denoted as second graph data.

Hereinafter, the graph data may be simply denoted as a graph. For example, the target graph data may be denoted as a target graph, the first graph data may be denoted as a first graph, and the second graph data may be denoted as a second graph. The target information (object) may be any type of information as long as it can be expressed as a vector. While the following will describe vector information as image information, the target of the vector information may be another target such as video information or audio information.

In addition, as illustrated in FIG. 1, the generation apparatus 100 performs generation processing on graph data as a target. The directed edge here represents an edge by which data can be traced only in one direction. Hereinafter, a source of the tracing by an edge, that is, a node serving as a start point is defined as a reference source, and a destination of the tracing by the edge, that is, a node serving as an end point is defined as a reference destination. For example, a directed edge linked from a predetermined node “A” to a predetermined node “B” indicates an edge having a reference source of node “A” and having a reference destination of node “B”.

Hereinafter, the edge having the reference source of node “A” in this manner will be denoted as an output edge of node “A”. In addition, hereinafter, the edge having the reference destination of node “B” in this manner will be denoted as an input edge of node “B”. That is, the output edge and the input edge described herein are determined by the difference in defining one directed edge to be based on which one node among two nodes linked by the directed edge, and thus, the one directed edge can be one of the output edge and the input edge, accordingly. More specifically, the output edge and the input edge are relative concepts, and thus, one directed edge can be an output edge when the edge is defined based on a node serving as a reference source, while the edge is defined as an input edge when the edge is defined based on a node serving as a reference destination. In the present embodiment, the edge is defined as a directed edge such as the output edge or the input edge, and thus, the directed edge may be simply denoted as an “edge” in the following.

Furthermore, each node here corresponds to each object. For example, each of the plurality of local features extracted from the image may be an object. Furthermore, for example, various data defining the distance between objects may be objects.

The generation apparatus 100 performs processing targeted for nodes corresponding to enormous image information of several millions to several hundreds of millions of units, for example, but only a part thereof is illustrated in the drawings. In order to simplify the description, an outline of the processing will be described by illustrating only some nodes and some edges in the example of FIG. 1. Specifically, FIG. 1 illustrates only six nodes N1 to N6 and the edges to be the output edges of any of the nodes, and for convenience of illustration, the edges will be described with reference numerals assigned to only some of edges E1 to E9 in a target graph GR10, for example.

In addition, when the node is denoted as “node N* (* is a certain numerical value)” in this manner, the node is to be a node identified by node ID “N*”. For example, when the node is denoted as a “node N1”, the node is a node identified by node ID “N1”. For example, in the example illustrated in FIG. 1, the vector data corresponding to each node may be an N-dimensional real value vector.

In addition, when an edge is denoted as “edge E* (* is a certain numerical value)” in this manner, the edge is an edge identified by edge ID “E*”. For example, when an edge is denoted as the “edge E1”, the edge is an edge identified by edge ID “E1”. For example, tracing from the node N1 to a node N2 can be performed by the edge E1 linked with the node N1 defined as a reference source and the node N2 defined as a reference destination. In this case, the edge E1, which is a directed edge, is an output edge when identified based on the node N1 and is an input edge when identified based on the node N2.

In other words, when viewed from the node N1 side, the edge E1, which is a directed edge, is an edge having its arrow directed from itself to another edge, that is, an outward edge, and when viewed from the node N2 side, the edge E1 is an edge having its arrow directed toward itself, that is, an inward edge. That is, the output edge here can be rephrased as the outward edge, and the input edge can be rephrased as the inward edge.

Furthermore, space information VS1-1 to VS1-5 illustrated in FIG. 1 are drawings schematically illustrating graph data generation processes, and the spaces illustrated in the space information VS1-1 to VS1-5 may be an identical space. Hereinafter, the space information VS1-1 to VS1-5 will be denoted as space information VS1 when described with no particular distinction.

Furthermore, the space information VS1 in FIG. 1 may be a Euclidean space. The space information VS1 in FIG. 1 is a conceptual drawing for illustrating information such as a distance between vectors, and the space information VS1 is a multidimensional space. For example, although the space information VS1 in FIG. 1 is illustrated in a two-dimensional mode in order to be illustrated on a plane, the space information VS1 is supposed to be a multidimensional space of 100 dimensions or 1000 dimensions, for example.

In addition, the first graphs GR11-1 and GR11-2 illustrated in FIG. 1 are drawings schematically illustrating graph data generation processes, and the first graphs GR11-1 and GR11-2 are the same first graphs generated by the generation processing. Hereinafter, the first graphs GR11-1 and GR11-2 will be denoted as a first graph GR11 when described without particular distinction.

In the present embodiment, the distance of each node in the space information VS1 is regarded as a similarity between corresponding objects. For example, it is assumed that the similarity of the target (image information) corresponding to each node is mapped as a distance between the nodes in the space information VS1. For example, it is assumed that the similarity between the concepts corresponding to the individual nodes is mapped to the distance between the nodes. Here, in the example illustrated in FIG. 1, the similarity is high between objects having a short distance between nodes in the space information VS1, and the similarity is low between objects having a long distance between nodes in the space information VS1. For example, in the space information VS1 in FIG. 1, the node identified by node ID “N4” and the node identified by node ID “N6” are close to each other, that is, the distance between the nodes is short. This indicates that the similarity is high between the object corresponding to the node identified by node ID “N4” and the object corresponding to the node identified by node ID “N6”.

On the other hand, in the space information VS1 in FIG. 1, for example, the node identified by node ID “N2” and the node identified by node ID “N3” are remote from each other, that is, the distance between the nodes is long. This indicates that the similarity is low between the object corresponding to the node identified by node ID “N2” and the object corresponding to the node identified by node ID “N3”. The distance as an index indicating the similarity may be any distance as long as the distance is applicable as a distance between vectors (N-dimensional vectors), that is, may be, for example, various distances such as a Euclidean distance, a Mahalanobis distance, or a cosine distance.

Hereinafter, the generation processing will be described in detail with reference to FIG. 1. Each step illustrated in FIG. 1 is a schematic step, provided for convenience, for describing a processing step of generating a second graph from a target graph, and thus, the actual processing may be performed in more detailed processing steps.

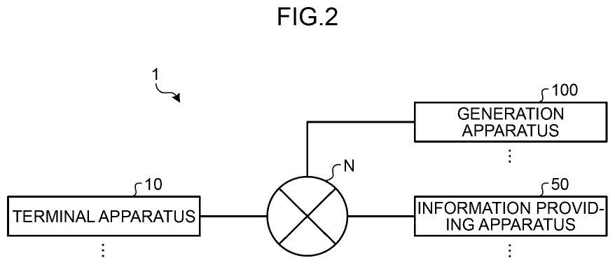

First, the generation apparatus 100 acquires a target graph (step S11). For example, the generation apparatus 100 acquires the target graph from a target graph data storage unit 122 (refer to FIG. 3). The generation apparatus 100 can acquire the target graph in any manner, and may acquire the target graph from an information providing apparatus 50 (refer to FIG. 2), for example.

In the example of FIG. 1, the generation apparatus 100 acquires a target graph GR10 as illustrated in the space information VS1-1. For example, the target graph GR10 may be a neighbor graph generated based on a predetermined criterion. Hereinafter, the approximate k-nearest neighbor graph will be described as an example of the target graph GR10. For example, the target graph GR10 is an approximate k-nearest neighbor graph in which k is “200”, or the like. Note that “200” is merely an example, and k may be various values, not limited to “200”.

Furthermore, the approximate k-nearest neighbor graph is merely an example of the target graph GR10, and the target graph GR10 may be, for example, a k-nearest neighbor graph. For example, the k-nearest neighbor graph is a graph in which an output edge to each of k nodes is linked in order from a node having a shorter distance from the node. For example, the approximate k-nearest neighbor graph is a concept including a graph based on a graph (Approximate k-Nearest Neighbor Graph (ANNG)), being a graph approximate to a k-nearest neighbor graph generated by performing k-nearest neighbor search using a graph being generated at the time of generating a graph index (graph).

The approximate k-nearest neighbor graph generated by the processing as described above may be a k-nearest neighbor graph. That is, the approximate k-nearest neighbor graph is a concept including a k-nearest neighbor graph. In addition, regarding the generation of the approximate k-nearest neighbor graph, it is possible to adopt any processing as disclosed in JP 6293335 B, Masajiro Iwasaki “Proximity Search using Approximate K Nearest Neighbor Graph with a Tree Structured Index”, Journal of Information Processing (Published by Information Processing Society of Japan), 2011/2, Vol. 52, No. 2. pp. 817-828, or the like, and thus detailed description thereof will be omitted. The approximate k-nearest neighbor graph is merely an example, and the target graph is not limited to the approximate k-nearest neighbor graph, and may be any graph as long as the graph is a graph in which a plurality of nodes is linked with a directed edge.

The generation apparatus 100 generates the first graph from the target graph data (step S12). The generation apparatus 100 extracts output edges of a first number from among output edges having each node as a start point, targeted for each of a plurality of nodes included in the target graph, and then generates a first graph in which the plurality of nodes is linked by an edge obtained by inverting the direction of the extracted output edge (also referred to as a “first inversion target edge”). For example, the generation apparatus 100 extracts, as the first inversion target edge, the output edges of the first number in order from a shorter length (distance) among the output edges having each node included in the target graph as a start point.

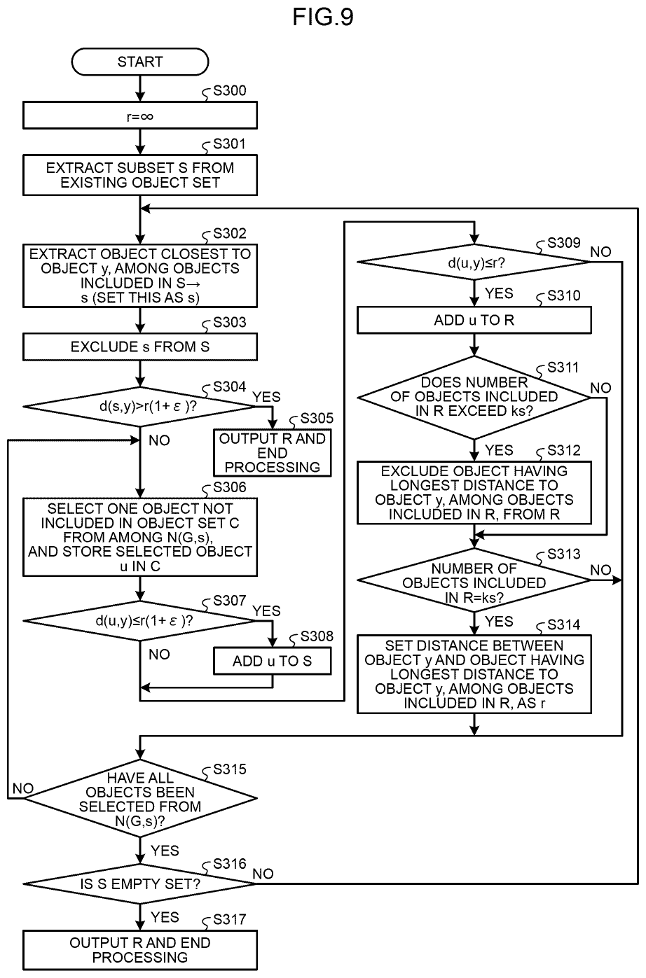

The generation apparatus 100 extracts the first inversion target edge by an optionally selected method. For example, the generation apparatus 100 may extract the first inversion target edges of the first number by using information of the length of each edge (distance between the connection nodes) stored in the target graph data storage unit 122. For example, the generation apparatus 100 may extract the first inversion target edges of the first number by search processing as illustrated in FIG. 9. Furthermore, the length of the edge (the distance between the connection nodes) is merely an example of the extraction criterion. The generation apparatus 100 may extract the first inversion target edges of the first number based on any criterion other than the length of the edge. For example, the generation apparatus 100 may randomly extract the output edges of the first number from the output edge having each node as a start point, as the first inversion target edge.

In FIG. 1, targeted for each of the plurality of nodes N1 to N6 and the like included in the target graph GR10, the generation apparatus 100 extracts hundred output edges in order from the shorter edge out of the output edges having each node as a start point, as the first inversion target edge. Subsequently, the generation apparatus 100 generates the first graph GR11 in which a plurality of nodes is linked by an edge obtained by inverting the direction of the first inversion target edge extracted from the target graph GR10 in units of hundred edges for each of the plurality of nodes N1 to N6 and the like. The number hundred is merely an example. The first number is not limited to hundred, and may be set to any value.

In this manner, the generation apparatus 100 inverts the direction of the output edge extracted as the first inversion target edge among the edges in the target graph, thereby generating the first graph having the edge in which the direction of the first inversion target edge is reversed among the edges of the target graph. That is, the generation apparatus 100 generates the first graph having the first inversion target edge whose direction is inverted, without changing the distance between the nodes and the like. The generation apparatus 100 may perform the processing in any order as long as the first graph can be generated from the target graph. For example, the generation apparatus 100 generates the first graph having the output edge extracted as the first inversion target edge among the edges in the target graph, inverts the direction of the edge of the generated first graph to update the first graph, thereby generating the first graph having the edge in which the direction of the first inversion target edge is reversed among the edges of the target graph.

In the example of FIG. 1, the generation apparatus 100 generates the first graph GR11-1 as illustrated in the space information VS1-2, from the target graph GR10. The generation apparatus 100 generates the first graph GR11-1 being a transpose graph of the target graph GR10. For example, the generation apparatus 100 generates the first graph GR11 by interchanging the start point and the end point of the edge extracted as the first inversion target edge in the target graph GR10. For example, the generation apparatus 100 inverts the edge E1 having the node N1 as a start point and having the node N2 as an end point to generate the first graph GR11 including an edge E1a having the node N2 as a start point and having the node N1 as an end point, as illustrated in the space information VS1-2. With this processing, based on the target graph GR10, the generation apparatus 100 generates the first graph GR11 in which the number of input edges to each of the plurality of nodes N1 to N6 and the like is the first number. In this manner, the generation apparatus 100 can generate the first graph having a uniform number of input edges to each node, based on the target graph.

In addition, the generation apparatus 100 extracts output edges of a smaller number (the number will be denoted as “Ko”), smaller than the first number, among the output edges having each node included in the target graph as a start point (step S13). The relationship between the number of Ko and the first number is not limited to the above, and for example, the number of Ko may be the first number or more. For example, the generation apparatus 100 extracts Ko output edges (also denoted as “addition target edges”) in order from the shorter edge out of the output edges having each node included in the target graph as a start point.

The generation apparatus 100 extracts the addition target edge by an optionally selected method. For example, the generation apparatus 100 may extract Ko addition target edges by using information of the length of each edge (distance between the connection nodes) stored in the target graph data storage unit 122. For example, the generation apparatus 100 may extract Ko addition target edges by search processing as illustrated in FIG. 9. Furthermore, the length of the edge (the distance between the connection nodes) is merely an example of the extraction criterion. The generation apparatus 100 may extract Ko addition target edges based on any criterion other than the length of the edge. For example, the generation apparatus 100 may randomly extract Ko output edges from the output edge having each node as a start point, as the addition target edges.

In FIG. 1, targeted for each of the plurality of nodes N1 to N6 and the like included in the target graph GR10, the generation apparatus 100 extracts ten output edges in order from the shorter edge out of the output edges having each node as a start point, as the addition target edges. The number ten is merely an example, and the number Ko is not limited to ten. For example, any value may be set as long as the number is smaller than the first number. As indicated by a temporary graph GR12 in the space information VS1-3, the generation apparatus 100 extracts an output edge such as the edge E1 as the addition target edge. Incidentally, the temporary graph GR12 is a graph for indicating an edge extracted as an addition target edge. The generation apparatus 100 may generate the temporary graph GR12, but may omit generation of the temporary graph GR12 as long as the addition target edge can be specified.

Subsequently, the generation apparatus 100 adds an edge to the first graph (step S14). The generation apparatus 100 adds the output edge extracted as the addition target edge from the target graph to the first graph, thereby adding the edge to the first graph.

In FIG. 1, by adding an edge to the first graph 11, the generation apparatus 100 generates the first graph GR11-2 as illustrated in the space information VS1-4. The generation apparatus 100 adds the output edge such as the edge E1 being an addition target edge illustrated in the temporary graph GR12 to the first graph GR11-1, thereby generating the first graph GR11-2 to which the addition target edge has been added. For example, the generation apparatus 100 adds an edge E7, which is the addition target edge, to the first graph GR11-1 to generate the first graph GR11-2 to which the addition target edge has been added.

In FIG. 1, regarding the edges other than the edge E7 among the illustrated addition target edges, there is another edge having the same reference source and reference destination as the edge in the first graph GR11, and thus the addition target edges need not be added.

While FIG. 1 illustrates a case where the addition target edge is added to the first graph, the addition target edge need not be added to the first graph. For example, the addition target edge may be added to the second graph. When the addition target edge is not added to the first graph, the first graph GR11 in the state illustrated in the first graph GR11-1 may be used in the generation processing of the second graph illustrated in step S21.

Subsequently, the generation apparatus 100 generates the second graph from the first graph (step S21). The generation apparatus 100 extracts output edges of a second number from among output edges having each node as a start point, targeted for each of a plurality of nodes included in the first graph, and then generates the second graph in which the plurality of nodes is linked by an edge obtained by inverting the direction of the extracted output edge (also referred to as “second inversion target edge”). For example, the generation apparatus 100 extracts, as the second inversion target edge, the output edges of the second number in order from a shorter length (distance) among the output edges having each node included in the first graph as a start point.

The generation apparatus 100 extracts the second inversion target edge by an optionally selected method. For example, the generation apparatus 100 may extract the second inversion target edges of the second number by using information of the length of each edge (distance between the connection nodes) stored in a first graph data storage unit 123. For example, the generation apparatus 100 may extract the second inversion target edges of the second number by search processing as illustrated in FIG. 9. Furthermore, the length of the edge (the distance between the connection nodes) is merely an example of the extraction criterion. The generation apparatus 100 may extract the second inversion target edges of the second number based on any criterion other than the length of the edge. For example, the generation apparatus 100 may randomly extract the output edges of the second number from the output edge having each node as a start point, as the second inversion target edge.

In FIG. 1, targeted for each of the plurality of nodes N1 to N6 and the like included in the first graph GR11, the generation apparatus 100 extracts hundred output edges in order from the shorter edge out of the output edges having each node as a start point, as the second inversion target edge. Subsequently, the generation apparatus 100 generates the second graph GR21 in which a plurality of nodes is linked by an edge obtained by inverting the direction of the second inversion target edge extracted from the first graph GR11 in units of hundred edges for each of the plurality of nodes N1 to N6 and the like. The number hundred is merely an example. The second number is not limited to hundred, and may be set to any value. For example, the second number may be a value different from the first number.

In this manner, the generation apparatus 100 inverts the direction of the output edge extracted as the second inversion target edge among the edges in the first graph, thereby generating the second graph having the edge in which the direction of the second inversion target edge is reversed among the edges of the first graph. That is, the generation apparatus 100 generates the second graph having the second inversion target edge whose direction is inverted, without changing the distance between the nodes and the like. The generation apparatus 100 may perform the processing in any order as long as the second graph can be generated from the first graph. For example, the generation apparatus 100 generates the second graph having the output edge extracted as the second inversion target edge among the edges in the first graph, inverts the direction of the edge of the generated second graph to update the second graph, thereby generating the second graph having the edge in which the direction of the second inversion target edge is reversed among the edges of the first graph.

In the example of FIG. 1, the generation apparatus 100 generates the second graph GR21 as illustrated in the space information VS1-5, from the first graph GR11. The generation apparatus 100 generates the second graph GR21 being a transpose graph of the first graph GR11. For example, the generation apparatus 100 generates the second graph GR21 by interchanging the start point and the end point of the edge extracted as the second inversion target edge in the first graph GR11. For example, the generation apparatus 100 inverts the edge E4a having the node N1 as a start point and having the node N2 as an end point to generate the second graph GR21 including an edge E4b having the node N2 as a start point and having the node N1 as an end point as illustrated in the space information VS1-5. With this processing, based on the first graph GR11, the generation apparatus 100 generates the second graph GR21 in which the number of input edges to each of the plurality of nodes N1 to N6 and the like is the second number.

As described above, the generation apparatus 100 can generate the second graph having a uniform number of input edges to each node, based on the first graph. In addition, since the generation apparatus 100 sets the uniform number of input edges to each node at the stage of generating the first graph, it is possible to suppress an increase in the number of edges that can be output edges from each node at the stage of the second graph. In this manner, the generation apparatus 100 performs two sessions of processing of inverting the direction of the edge to generate the graph, making it possible to generate a graph having a suppressed number of output edges and a uniform number of input edges. Accordingly, the generation apparatus 100 can generate graph data for generating an appropriate graph.

The processing illustrated in FIG. 1 is merely an example, and the generation apparatus 100 may generate the second graph by various types of processing. For example, the generation apparatus 100 may add an edge to the second graph. For example, the generation apparatus 100 may add the addition target edge extracted in step S13 to the second graph, thereby adding the edge to the second graph. In this case, the number Ko is not limited to ten. For example, any value may be set as long as the number is smaller than the second number.

In addition, the generation apparatus 100 may add the edge to the second graph by extracting an addition target edge (also referred to as a “second addition target edge”) targeted for the first graph and adding the extracted second addition target edge to the second graph. In this case, targeted for each of the plurality of nodes N1 to N6 and the like included in the first graph GR11, it is also allowable to extract ten output edges in order from the shorter edge out of the output edges having each node as a start point, as the second addition target edge. The number ten is merely an example. The extraction number of the second addition target edge is not limited to ten, and may be set to any value. For example, the extraction number of the second addition target edges may be any value other than ten (for example, may be the same value as Ko number) as long as the number is smaller than the second number.

Conventionally, a neighbor graph (including a k-nearest neighbor graph or the like) having a graph structure in which each node is connected to a neighboring node by a directed edge has been used for nearest neighbor search or proximity search. In such a search using a neighbor graph including a directed edge, a node having too few input edges would decrease the possibility of reaching the node, leading to deterioration in search accuracy. On the other hand, a node having too many output edges would increase the number of distance computations, leading to an increase in search time.

In the graph such as the ANNG described above, there are nodes having an extremely large number of edges, and transposing these nodes would lead to the presence of nodes having a large number of output edges. Depending on the data set, this leads to deterioration of the speed of the search processing or the like. To handle this, there has been a conventional method of reducing edges of nodes having a large number of output edges in a graph generated by performing one session of transposition. In such a conventional method, since a certain number of output edges are transposed for the purpose of making the number of input edges constant, the number of input edges is likely to fluctuate.

In view of this, by performing the 2-session edge transposition processing, that is, performing transposition again targeted for a constant number of output edges for the graph (first graph) generated by performing one session of transposition, the generation apparatus 100 makes it possible to suppress the number of output edges and achieve a constant number of input edges. In other words, the generation apparatus 100 suppresses generation of the second graph including the node having the extremely small number of input edges or the node having the extremely large number of output edges, and generates the second graph having a suppressed number of output edges and a uniform number of input edges. With this processing, the generation apparatus 100 generates a desired second graph and enables improvement in search performance by the second graph.

For example, in a case where a node including output edges of a large number (for example, 1000 or 10000) are included in graph data, a processing load of search for tracing the node would be high. In addition, for example, in a case where a node including input edges of a small number (for example, 0 or 1) are included in the graph data, the likelihood of successful search of the node would be low. In this manner, by adjusting edges, for each node, so as to prevent occurrence of non-uniformity in the output edge or the input edge, in particular, prevent an increase of the output edges of a specific node, the generation apparatus 100 can reduce the likelihood of including a node involving high processing load or a node having a low likelihood of successful search. Accordingly, the generation apparatus 100 can generate graph data for generating an appropriate graph.

In addition, the generation apparatus 100 may generate index data to be used at the time of search. For example, the generation apparatus 100 generates a search index, being an index to be used in the search for a high-dimensional vector, as index data. The high-dimensional vector referred to herein may be, for example, a vector of several hundred dimensions to several thousand dimensions, or a vector of more dimensions.

For example, the generation apparatus 100 may generate a search index related to a tree structure, as index data. For example, the generation apparatus 100 may generate a search index related to a k-dimensional tree (kd tree), as index data. For example, the generation apparatus 100 may generate a search index related to a Vantage-Point tree (VP tree) as index data.

Furthermore, for example, the generation apparatus 100 may generate index data having another type of tree structure. For example, the generation apparatus 100 may generate various types of index data in which a leaf of index data having a tree structure is connected to graph data. For example, the generation apparatus 100 may generate various types of index data in which a leaf of index data having a tree structure corresponds to a node in a graph such as the second graph. When performing a search using such index data, the generation apparatus 100 may explore graph data from a leaf (node) reached by tracing the index data.

The index data as described above is an example, and the generation apparatus 100 may generate index data of any data structure as long as the query in the graph data can be specified at a high speed. For example, when it is possible to specify centroid information corresponding to the query at a high speed, the generation apparatus 100 may generate index data by appropriately using various conventional technologies such as a technology related to binary space partitioning. For example, the generation apparatus 100 may generate index data of any data structure as long as the index is compatible with search for a high-dimensional vector. The generation apparatus 100 can enable more efficient search for a predetermined target by using the index data and the graph such as the second graph as described above.

### 2. Configuration of Generation System

As illustrated in FIG. 2, a generation system 1 includes a terminal apparatus 10, an information providing apparatus 50, and a generation apparatus 100. The terminal apparatus 10, the information providing apparatus 50, and the generation apparatus 100 are communicably connected to each other in a wired or wireless channel via a predetermined network N. FIG. 2 is a diagram illustrating a configuration example of the generation system according to the embodiment. The generation system 1 illustrated in FIG. 2 may include a plurality of terminal apparatuses 10, a plurality of information providing apparatuses 50, and a plurality of generation apparatuses 100.

The terminal apparatus 10 is an information processing apparatus used by a user. The terminal apparatus 10 receives various operations performed by the user. Hereinafter, the terminal apparatus 10 may be denoted as a user. That is, hereinafter, the user can be rephrased as the terminal apparatus 10. The terminal apparatus 10 described above is implemented by an apparatus such as a smartphone, a tablet terminal, a laptop personal computer (PC), a desktop PC, a mobile phone, a personal digital assistant (PDA), for example.

The information providing apparatus 50 is an information processing apparatus storing information for providing various types of information to a user or the like. For example, the information providing apparatus 50 stores object ID based on character information or the like collected from various external apparatuses such as a web server. For example, the information providing apparatus 50 is an information processing apparatus that provides an image search service to the user or the like. For example, the information providing apparatus 50 stores each piece of information for providing the image search service. For example, the information providing apparatus 50 provides vector information corresponding to an image as a target of the image search service to the generation apparatus 100. Furthermore, the information providing apparatus 50 transmits the query to the generation apparatus 100, thereby receiving object ID or the like indicating the image corresponding to the query from the generation apparatus 100.

The generation apparatus 100 is an information processing apparatus (computer) that executes generation processing, being processing of generating a graph. The generation apparatus 100 generates a graph by 2-session edge transposition. For example, the generation apparatus 100 extracts output edges of a first number from among output edges having each node as a start point, targeted for each of a plurality of nodes included in the target graph, and then generates a first graph in which the plurality of nodes is linked by an edge obtained by inverting the direction of the extracted output edge. For example, the generation apparatus 100 extracts output edges of a second number from among output edges having each node as a start point, targeted for each of a plurality of nodes included in the first graph, and then generates a second graph in which the plurality of nodes is linked by an edge obtained by inverting the direction of the extracted output edge.

After receiving query information (hereinafter, also simply referred to as a “query”) from the terminal apparatus 10, the generation apparatus 100 may search for a target (vector information or the like) similar to the query and provide a search result to the terminal apparatus 10. Furthermore, for example, the data provided by the generation apparatus 100 to the terminal apparatus 10 may be a data item such as image information, or may be information for referring to corresponding data, such as a uniform resource locator (URL). Furthermore, the data of the query or the search target may be any type of data such as image, audio, or text data. In the present embodiment, a case where the generation apparatus 100 searches for an image will be described as an example.

### 3. Configuration of Generation Apparatus

Next, a configuration of the generation apparatus 100 according to the embodiment will be described with reference to FIG. 3. FIG. 3 is a diagram illustrating a configuration example of the generation apparatus 100 according to the embodiment. As illustrated in FIG. 3, the generation apparatus 100 includes a communication unit 110, a storage unit 120, and a control unit 130. The generation apparatus 100 may include: an input unit (such as a keyboard and a mouse, for example) that receives various operations from an administrator or the like of the generation apparatus 100; and a display unit (such as a liquid crystal display, for example) for displaying various types of information.

### Communication Unit 110

The communication unit 110 is implemented by a device such as a network interface card (NIC), for example. The communication unit 110 is connected to a network (for example, the network N in FIG. 2) in a wired or wireless channel, and transmits and receives information to and from the terminal apparatus 10 and the information providing apparatus 50.

### Storage Unit 120

The storage unit 120 is implemented by, for example, a semiconductor memory element such as random access memory (RAM) and flash memory, or a storage device such as a hard disk and an optical disk. As illustrated in FIG. 3, the storage unit 120 according to the embodiment includes an object information storage unit 121, a target graph data storage unit 122, a first graph data storage unit 123, a second graph data storage unit 124, and a processing information storage unit 125.

### Object Information Storage Unit 121

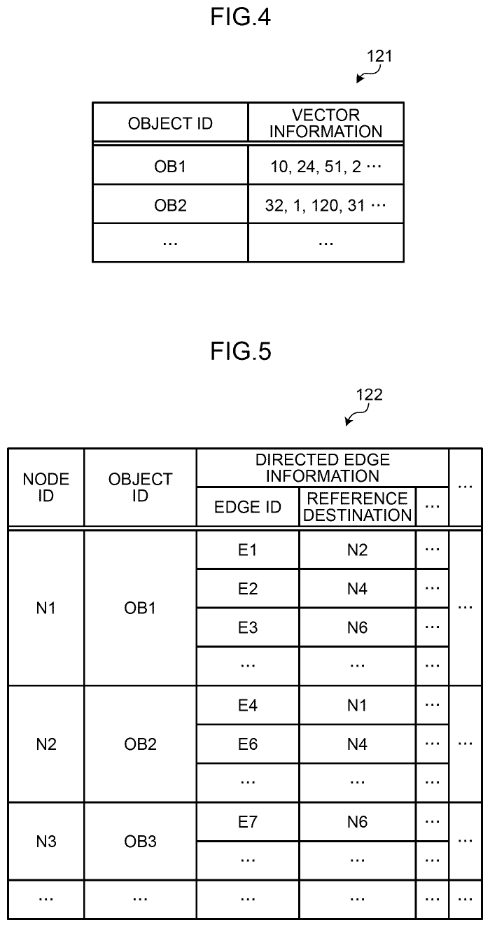

The object information storage unit 121 according to the embodiment stores various types of information related to an object. For example, the object information storage unit 121 stores object ID and vector data. FIG. 4 is a diagram illustrating an example of an object information storage unit according to the embodiment. The object information storage unit 121 illustrated in FIG. 4 includes items such as “object ID” and “vector information”.

The “object ID” indicates identification information for identifying an object. The “Vector information” indicates vector information corresponding to the object identified by the object ID. That is, in the example of FIG. 4, vector data (vector information) corresponding to an object is registered in association with the object ID identifying the object.

For example, the example of FIG. 4 indicates that the object (target) identified by the ID “OB1” is associated with multidimensional vector information of “10, 24, 51, 2 . . . ”.

The object information storage unit 121 is not limited to the above, and may store various types of information depending on the purpose.

### Target Graph Data Storage Unit 122

The target graph data storage unit 122 according to the embodiment stores various types of information related to graph data. For example, the target graph data storage unit 122 stores target graph data to be a target of 2-session edge transposition processing. For example, the target graph data storage unit 122 stores existing neighbor graph data.

FIG. 5 is a diagram illustrating an example of the target graph data storage unit according to the embodiment. The target graph data storage unit 122 illustrated in FIG. 5 includes items such as “node ID”, “object ID”, and “directed edge information”. The “directed edge information” includes information such as “edge ID” and “reference destination”.

The “node ID” indicates identification information for identifying each node (target) in the graph data. The “object ID” indicates identification information for identifying an object.

Furthermore, the “directed edge information” indicates information related to an edge connected to the corresponding node. In the example of FIG. 5, the “directed edge information” indicates information related to the output edge output from the corresponding node. In addition, “edge ID” indicates identification information for identifying an edge linking the nodes. The “reference destination” indicates information indicating a reference destination (node) linked by an edge. That is, in the example of FIG. 5, information identifying an object (target) corresponding to a node and a reference destination (node) to which a directed edge (output edge) from the node is linked are registered in association with the node ID identifying the node.

For example, the example of FIG. 5 indicates that the node (node N1) identified by the node ID “N1” corresponds to the object (target) identified by the object ID “OB1”. In addition, the diagram indicates that the node N1 has the edge (the edge E1) identified by the edge ID “E1” linked to the node (node N2) identified by the node ID “N2”. That is, the example of FIG. 5 indicates that it is possible to perform tracing from the node N1 in the target graph data to the node N2 by the edge E1.

The target graph data storage unit 122 is not limited to the above, and may store various types of information according to the purpose. For example, the target graph data storage unit 122 may store the length of the edge linking the nodes (vectors). That is, the target graph data storage unit 122 may store information indicating the distance between the nodes (vectors).

### First Graph Data Storage Unit 123

The first graph data storage unit 123 according to the embodiment stores various types of information related to the first graph data. For example, the first graph data storage unit 123 stores first graph data (for example, the first graph GR11 or the like), being graph data obtained by performing one session of edge transposition processing on the target graph data. For example, the first graph data storage unit 123 stores graph data obtained by performing one session of edge transposition processing on the neighboring graph data.

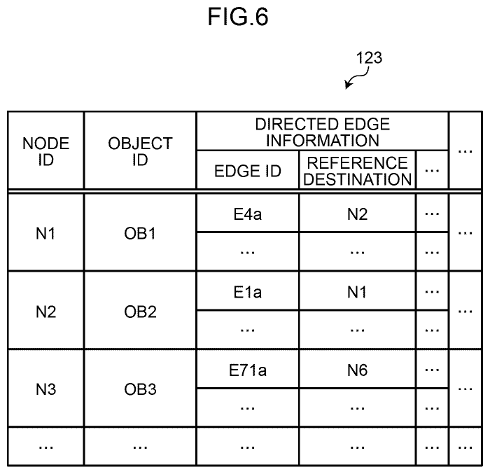

FIG. 6 is a diagram illustrating an example of the first graph data storage unit according to the embodiment. The first graph data storage unit 123 illustrated in FIG. 6 includes items such as “node ID”, “object ID”, and “directed edge information”. The “directed edge information” includes information such as “edge ID” and “reference destination”.

The items “node ID,” “object ID,” and “directed edge information” in the first graph data storage unit 123 are similar to the items “node ID,” “object ID,” and “directed edge information” in the target graph data storage unit 122, and thus, detailed description thereof is omitted. For example, the example of FIG. 6 indicates that the node identified by the node ID “N1” corresponds to the object (target) identified by the object ID “OB1”. In addition, the diagram indicates that the node N1 has the edge (the edge E4a) identified by the edge ID “E4a” linked to the node (node N2) identified by the node ID “N2”. That is, the example of FIG. 6 indicates that it is possible to perform tracing from the node N1 in the first graph data to the node N2 by the edge E4a. As described above, since the edge ID “E4a” is equivalent to the edge ID “E1”, the edge ID “E1” may be used instead of the edge ID “E4a” in the first graph data, similarly to the target graph data.

The first graph data storage unit 123 is not limited to the above, and may store various types of information according to the purpose. For example, the first graph data storage unit 123 may store the length of the edge linking the nodes (vectors). That is, the first graph data storage unit 123 may store information indicating the distance between the nodes (vectors).

### Second Graph Data Storage Unit 124

The second graph data storage unit 124 according to the embodiment stores various types of information related to the second graph data. For example, the second graph data storage unit 124 stores second graph data (for example, the second graph GR21 or the like), being graph data obtained by performing one session of edge transposition processing on the first graph data. For example, the second graph data storage unit 124 stores graph data obtained by performing two sessions of edge transposition processing on the neighboring graph data.

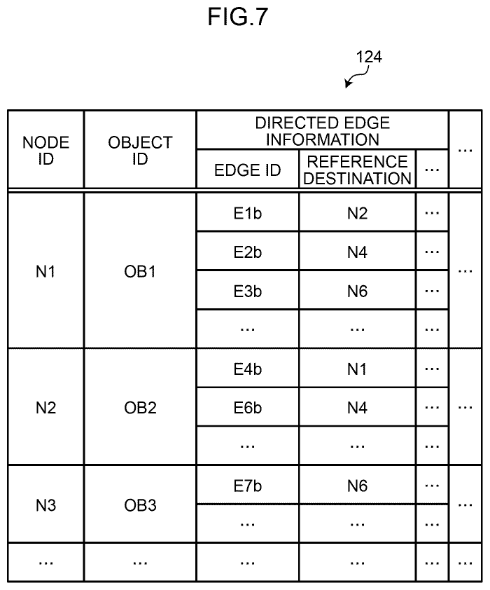

FIG. 7 is a diagram illustrating an example of the second graph data storage unit according to the embodiment. The second graph data storage unit 124 in an example of FIG. 7 includes items such as “node ID”, “object ID”, and “directed edge information”. The “directed edge information” includes information such as “edge ID” and “reference destination”.

The items “node ID”, “object ID”, and “directed edge information” in the second graph data storage unit 124 are similar to the items “node ID”, “object ID”, and “directed edge information” in the target graph data storage unit 122 and the first graph data storage unit 123, and thus, detailed description thereof is omitted.

For example, the example of FIG. 7 indicates that the node identified by the node ID “N1” corresponds to the object (target) identified by the object ID “OB1”. In addition, the diagram indicates that the node N1 has the edge (the edge E1b) identified by the edge ID “E1b” linked to the node (node N2) identified by the node ID “N2”. That is, the example of FIG. 7 indicates that it is possible to perform tracing from the node N1 in the second graph data to the node N2 by the edge E1b. As described above, since the edge ID “E1b” is equivalent to the edge ID “E1”, the edge ID “E1” may be used instead of the edge ID “E1b” in the second graph data, similarly to the target graph data.

The second graph data storage unit 124 is not limited to the above, and may store various types of information according to the purpose. For example, the second graph data storage unit 124 may store the length of the edge linking the nodes (vectors). That is, the second graph data storage unit 124 may store information indicating the distance between the nodes (vectors). For example, the second graph data storage unit 124 may store information indicating the number of input edges to each node.

The graph data such as the target graph data, the first graph data, and the second graph data described above may include a program module that receives a query as an input, explore a node by tracing an edge in the graph data, and extracts and outputs a node similar to the query. In this case, for example, the second graph data may be data assumed to be used as a program module that performs search processing using the second graph. For example, the second graph data GR21 may be a program that extracts a node corresponding to vector data similar to the vector data that has been input as a query, from the second graph and outputs the extracted node. For example, the second graph data GR21 may be data used as a program module of searching for a similar image corresponding to the query image. For example, the second graph data GR21 causes the computer to function to extract and output a node similar to the query in the second graph based on the input query.

### Processing Information Storage Unit 125

The processing information storage unit 125 according to the embodiment stores various types of information used for graph generation processing. The processing information storage unit 125 stores various types of information used for each processing included in the generation of the second graph from the target graph.

The processing information storage unit 125 stores information indicating a criterion for extraction from the graph. The processing information storage unit 125 stores an extraction condition indicating that an edge is to be extracted in order from a shorter length (distance) from the graph. For example, the processing information storage unit 125 stores a designation value (threshold or the like) of the number of edges to be extracted from the graph.

For example, the processing information storage unit 125 stores a first designation value (first threshold) of the number of output edges (first number) to be extracted from the target graph to be added with an inverted direction to the first graph. For example, the processing information storage unit 125 stores a second designation value (second threshold) of the number of output edges (second number) to be extracted from the first graph to be added with an inverted direction to the second graph.

For example, the processing information storage unit 125 stores a first designation value (third threshold) of the number of output edges (third number such as Ko) to be extracted from the target graph to be added, with no change, to the first graph. For example, the processing information storage unit 125 stores a first designation value (fourth threshold) of the number of output edges (fourth number such as Ko) to be extracted from the target graph to be added, with no change, to the second graph. For example, the processing information storage unit 125 stores a first designation value (fifth threshold) of the number of output edges (fifth number such as Ko) to be extracted from the first graph to be added, with no change, to the second graph.

The processing information storage unit 125 is not limited to the above, and may store various types of information depending on the purpose.

### Control Unit 130

Returning to the description of FIG. 3, the control unit 130 is a controller, and is implemented by a unit such as a central processing unit (CPU) and a micro processing unit (MPU), for example, executing various programs (corresponding to an example of a generation program) stored in a storage device inside the generation apparatus 100 using the RAM as a work area. Furthermore, the control unit 130 is a controller, and is implemented by an integrated circuit such as an application specific integrated circuit (ASIC) or a field programmable gate array (FPGA), for example.

As illustrated in FIG. 3, the control unit 130 includes an acquisition unit 131, a generation unit 132 that functions as a first generation unit and a second generation unit, a search unit 133, and a providing unit 134, and implements or executes a function and an action of information processing described below. The internal configuration of the control unit 130 is not limited to the configuration illustrated in FIG. 3, and may be another configuration as long as it performs information processing described below. For example, the generation unit 132 may be separated into: a first generation unit 132a that executes processing of generating the first graph; and a second generation unit 132b that executes processing of generating the second graph.

### Acquisition Unit 131

The acquisition unit 131 acquires various types of information. For example, the acquisition unit 131 acquires various types of information from the storage unit 120. For example, the acquisition unit 131 acquires various types of information from the object information storage unit 121, the target graph data storage unit 122, the first graph data storage unit 123, the processing information storage unit 125, and the second graph data storage unit 124. Furthermore, the acquisition unit 131 acquires various types of information from an external information processing apparatus.

The acquisition unit 131 acquires a target graph, being a graph in which a plurality of nodes corresponding to a plurality of objects to be a target of data search is linked by edges. The acquisition unit 131 acquires a target graph that is a neighbor graph.

In the example of FIG. 1, the acquisition unit 131 acquires the target graph GR10. For example, the acquisition unit 131 may receive target graph data such as existing neighbor graph data from an external apparatus such as the information providing apparatus 50.

For example, the acquisition unit 131 acquires information related to the search query. For example, the acquisition unit 131 acquires a search query related to image search. For example, the acquisition unit 131 receives a query from the terminal apparatus 10 used by the user. For example, the acquisition unit 131 may acquire graph designation information indicating designation of a graph by the user. For example, the acquisition unit 131 may acquire graph designation information indicating designation of which one of the target graph, the first graph, and the second graph is to be used for search. In this case, the acquisition unit 131 may cause the user to receive graph designation information indicating designation by the user from the terminal apparatus 10.

### Generation Unit 132

The generation unit 132 executes generation processing of generating various types of information. The generation unit 132 generates a graph by performing two sessions of transposition of the edge. The generation unit 132 selects various types of information. The generation unit 132 extracts various types of information.

For example, the generation unit 132 generates various types of information (data) from the information (data) stored in the storage unit 120. For example, the generation unit 132 generates various types of information from the object information storage unit 121, the target graph data storage unit 122, the first graph data storage unit 123, or the processing information storage unit 125. For example, the generation unit 132 generates the first graph data from the target graph data. For example, the generation unit 132 generates the second graph data from the first graph data. For example, the generation unit 132 generates the second graph data from the target graph data and the first graph data.

The generation unit 132 extracts output edges of a first number from among output edges having each node as a start point, targeted for each of a plurality of nodes included in the target graph, and then generates a first graph in which the plurality of nodes is linked by an edge obtained by inverting the direction of the extracted output edge. The generation unit 132 extracts output edges of a fourth number from among output edges having each node as a start point, targeted for each of a plurality of nodes included in the target graph, and then adds the extracted output edges to the first graph.

The generation unit 132 extracts output edges of the fourth number, being smaller than the first number, from among output edges having each node included in the target graph as a start point. The generation unit 132 extracts output edges of the first number in order from a shorter edge, from among output edges having each node included in the target graph as a start point.

The generation unit 132 extracts output edges of a first number from among output edges having each node as a start point, targeted for each of a plurality of nodes included in the neighbor graph, and then generates a first graph in which the plurality of nodes is linked by an edge obtained by inverting the direction of the extracted output edge.

The generation unit 132 extracts output edges of a second number from among output edges having each node as a start point, targeted for each of a plurality of nodes included in the first graph, and then generates a second graph in which the plurality of nodes is linked by an edge obtained by inverting the direction of the extracted output edge.

For example, the generation unit 132 extracts output edges of a third number from among output edges having each node as a start point, targeted for each of a plurality of nodes included in the target graph, and then adds the extracted output edges to the second graph. The generation unit 132 extracts output edges of the third number, being smaller than the second number, from among output edges having each node included in the target graph as a start point.

For example, the generation unit 132 extracts output edges of a fifth number from among output edges having each node as a start point, targeted for each of a plurality of nodes included in the first graph, and then adds the extracted output edges to the second graph. The generation unit 132 extracts output edges of the fifth number, being smaller than the second number, from among output edges having each node included in the first graph as a start point. The generation unit 132 extracts output edges of the second number in order from a shorter edge, from among output edges having each node included in the first graph as a start point.

### Search Unit 133

The search unit 133 searches for various types of information. The search unit 133 executes search processing using a graph. The search unit 133 functions as an extraction unit that extracts various types of information. The search unit 133 extracts various types of information. For example, the search unit 133 provides a search service related to an object. For example, the search unit 133 explores graph data to search for an object.

The search unit 133 executes search processing of searching for a graph in accordance with an instruction from the generation unit 132. For example, in a case where information indicating an object (node) to be a processing target is given, the search unit 133 explores a graph based on a processing procedure as illustrated in FIG. 9 to extract an object (node) similar to the object (node) to be the processing target. The search unit 133 performs search processing of searching a graph, thereby extracts neighboring objects (neighboring nodes) of one object (node) among a plurality of objects (nodes), as the target object (target node). For example, the search unit 133 extracts a designated number of neighboring objects (neighboring nodes) from the generation unit 132.

For example, in a case where the query acquired by the acquisition unit 131 is acquired, the search unit 133 explores the graph data to search for an object similar to the query. For example, the search unit 133 explores the graph data to extract an object similar to the query. For example, the search unit 133 explores the graph data to extract an object similar to the query based on a processing procedure as illustrated in FIG. 9.

For example, in a case where the user has designated which one of the target graph, the first graph, and the second graph is to be used for the search, the search unit 133 performs search processing using the designated graph and extracts an object similar to the query.

### Providing Unit 134

The providing unit 134 provides various types of information. For example, the providing unit 134 provides various types of information to the terminal apparatus 10 and the information providing apparatus 50. For example, the providing unit 134 provides the object ID corresponding to the query, as a search result. For example, the providing unit 134 provides the object ID searched by the search unit 133 to the information providing apparatus 50 or the terminal apparatus 10. For example, the providing unit 134 provides the object ID extracted by the search unit 133 to the information providing apparatus 50 or the terminal apparatus 10. The providing unit 134 provides the object ID extracted by the search unit 133 to the information providing apparatus 50 or the terminal apparatus 10 as information indicating a vector corresponding to the query.

For example, when the user has designated which one of the target graph, the first graph, and the second graph is to be used for the search, the providing unit 134 transmits, to the terminal apparatus 10, an object similar to the query being a result of the search performed by the search unit 133 using the designated graph. In this case, the providing unit 134 may transmit information indicating the graph designated by the user to the terminal apparatus 10 together with the search result.

The providing unit 134 may provide the second graph data generated by the generation unit 132 to an external information processing apparatus. For example, the providing unit 134 may transmit the second graph GR21 generated by the generation unit 132 to the information providing apparatus 50.

### 4. Flow of Generation Processing

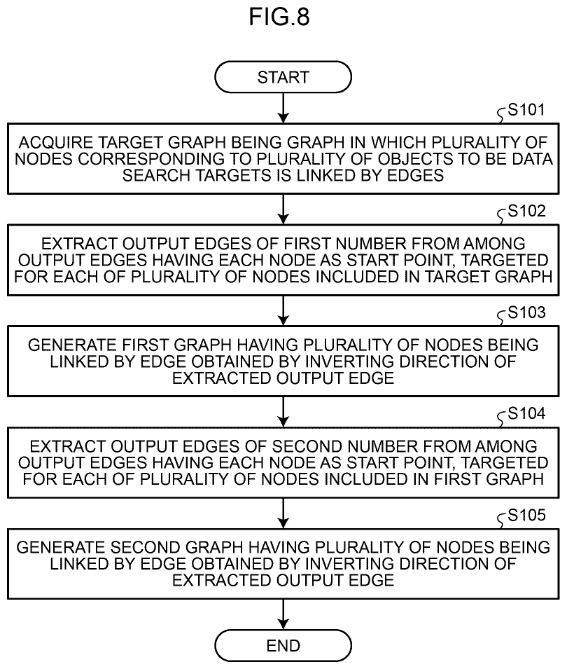

Next, a procedure of generation processing performed by the generation system 1 according to the embodiment will be described with reference to FIG. 8. FIG. 8 is a flowchart illustrating an example of generation processing according to the embodiment.

As illustrated in FIG. 8, the generation apparatus 100 acquires a target graph being a graph in which a plurality of nodes corresponding to a plurality of objects to be data search targets is linked by edges (step S101). For example, the generation apparatus 100 acquires the target graph data from the target graph data storage unit 122. In the example of FIG. 1, the generation apparatus 100 acquires the target graph GR10.

The generation apparatus 100 extracts output edges of the first number from among output edges having each node as a start point, targeted for each of a plurality of nodes included in the target graph (step S102). Subsequently, the generation apparatus 100 generates the first graph having the plurality of nodes being linked by the edge obtained by inverting the direction of the extracted output edge (step S103). In the example of FIG. 1, the generation apparatus 100 generates the first graph GR11 from the target graph GR10.

The generation apparatus 100 extracts output edges of the second number from among output edges having each node as a start point, targeted for each of a plurality of nodes included in the first graph (step S104). Subsequently, the generation apparatus 100 generates the second graph having the plurality of nodes being linked by the edge obtained by inverting the direction of the extracted output edge (step S105). In the example of FIG. 1, the generation apparatus 100 generates the second graph GR21 from the first graph GR11.

### 5. Search Example

Here, an example of search using the above-described graph data will be described. The search using graph data is not limited to the following, and may be performed by various procedures, from which FIG. 9 will be described as an example. FIG. 9 is a flowchart illustrating an example of search processing using graph data. The search processing described below is performed by the search unit 133 of the generation apparatus 100. In addition, the object referred to below may be rephrased as a node. Although the following description assumes that the generation apparatus 100 (search unit 133) performs search processing, the search processing may be performed by another apparatus. In this case, the generation apparatus 100 may omit the search unit 133 and may request the search processing by transmitting a query to another apparatus and receive a result of the search processing from the another apparatus.

Here, the neighboring object set N(G, y) is a set of neighboring objects associated by an edge assigned to a node y. “G” may be a predetermined piece of graph data (such as the second graph GR21, for example). For example, the generation apparatus 100 executes k-nearest neighbor search processing.

For example, the generation apparatus 100 sets a radius r of a hypersphere to ∞ (infinity) (step S300), and extracts a subset S from the existing object set (step S301). For example, the generation apparatus 100 may extract an object (node) selected as the root node, as the subset S. For example, the hypersphere is a virtual sphere indicating the search range. The objects included in an object set S extracted in step S301 are simultaneously included in an initial set of an object set R of the search results.

Next, when the search query object is defined as y among the objects included in the object set S, the generation apparatus 100 extracts an object having the shortest distance to the object y, and sets the extracted object as an object s (step S302). For example, in a case where only the object (node) selected as the root node is an element of S, the generation apparatus 100 consequently extracts the root node as the object s. Next, the generation apparatus 100 excludes the object s from the object set S (step S303).

Next, the generation apparatus 100 determines whether a distance d(s, y) between the object s and the object y exceeds r(1+ε) (step S304). Here, ε is an extension element, and r(1+ε) represents a radius of an explore range (only nodes within the explore range are explored. Setting the explore range larger than the search range makes it possible to improve the accuracy). When the distance d(s, y) between the object s and the object y exceeds r(1+ε) (step S304: Yes), the generation apparatus 100 outputs the object set R as a neighboring object set of the object y (step S305), and ends the processing.

When the distance d(s, y) between the object s and the search query object y does not exceed r(1+ε) (step S304: No), the generation apparatus 100 selects one object not included in the object set C from among objects being elements of a neighboring object set N(G, s) of the object s, and stores a selected object u in the object set C (step S306). The object set C is provided for convenience in order to avoid duplicate search, and thus is set to an empty set at the start of processing.

Next, the generation apparatus 100 determines whether the distance d(u, y) between the object u and the object y is r(1+ε) or less (step S307). When the distance d(u, y) between the object u and the object y is r(1+ε) or less (step S307: Yes), the generation apparatus 100 adds the object u to the object set S (step S308). When the distance d(u, y) between the object u and the object y is not r(1+ε) or less (step S307: No), the generation apparatus 100 performs the determination (processing) of step S309.

Next, the generation apparatus 100 determines whether the distance d(u, y) between the object u and the object y is r or less (step S309). When the distance d(u, y) between the object u and the object y exceeds r, the generation apparatus 100 performs the determination (processing) of step S315. When the distance d(u, y) between the object u and the object y is not r or less (step S309: No), the generation apparatus 100 performs the determination (processing) of step S315.

When the distance d(u, y) between the object u and the object y is r or less (step S309: Yes), the generation apparatus 100 adds the object u to the object set R (step S310). Subsequently, the generation apparatus 100 determines whether the number of objects included in the object set R exceeds ks (step S311). The predetermined number ks is an optionally determined natural number. For example, ks may be 2 (ks=2). When the number of objects included in the object set R does not exceed ks (step S311: No), the generation apparatus 100 performs the determination (processing) of step S313.

When the number of objects included in the object set R exceeds ks (step S311: Yes), the generation apparatus 100 excludes the object having the longest distance (farthest) to the object y among the objects included in the object set R, from the object set R (step S312).

Next, the generation apparatus 100 determines whether the number of objects included in the object set R matches ks (step S313). When the number of objects included in the object set R does not match ks (step S313: No), the generation apparatus 100 performs the determination (processing) of step S315. When the number of objects included in the object set R matches ks (step S313: Yes), the generation apparatus 100 sets the distance between the object y and the object having the longest (farthest) distance to the object y, among the objects included in the object set R, as new r (step S314).

Subsequently, the generation apparatus 100 determines whether all the objects have been selected from the objects being elements of the neighboring object set N(G, s) of the object s and have been stored in the object set C (step S315). When not all the objects have been selected from the objects being the elements of the neighboring object set N(G, s) of the object s and have been stored in the object set C (step S315: No), the generation apparatus 100 returns to step S306 and repeats the processing.

When all the objects have been selected from the objects being the elements of the neighboring object set N(G, s) of the object s and have been stored in the object set C (step S315: Yes), the generation apparatus 100 determines whether the object set S is an empty set (step S316). When the object set S is not an empty set (step S316: No), the generation apparatus 100 returns to step S302 and repeats the processing. When the object set S is an empty set (step S316: Yes), the generation apparatus 100 outputs the object set R and ends the processing (step S317). For example, the generation apparatus 100 may provide the objects (nodes) included in the object set R to the terminal apparatus 10 or the like that has requested the search, as a search result corresponding to the search query (input object y).

### 6. Effects

As described above, the generation apparatus 100 according to the embodiment includes the acquisition unit (the “acquisition unit 131” in the embodiment; the same applies hereinbelow), the first generation unit (the “generation unit 132” in the embodiment; the same applies hereinbelow), and the second generation unit (the “generation unit 132” in the embodiment; the same applies hereinbelow). The acquisition unit acquires the target graph (the “target graph GR10” in the embodiment; the same applies hereinbelow) being a graph in which a plurality of nodes corresponding to a plurality of objects to be targets of data search is linked by edges. The first generation unit extracts output edges of a first number from among output edges having each node as a start point, targeted for each of a plurality of nodes included in the target graph, and then generates the first graph (the “first graph GR11” in the embodiment; the same applies hereinbelow) in which the plurality of nodes is linked by an edge obtained by inverting the direction of the extracted output edge. The second generation unit extracts output edges of a second number from among output edges having each node as a start point, targeted for each of a plurality of nodes included in the first graph, and then generates the second graph (the “second graph GR21” in the embodiment; the same applies hereinbelow) in which the plurality of nodes is linked by an edge obtained by inverting the direction of the extracted output edge.

In this manner, the generation apparatus 100 according to the embodiment performs two sessions of processing of inverting the direction of the edge to generate the graph, making it possible to generate a graph having a suppressed number of output edges and a uniform number of input edges. Accordingly, the generation apparatus 100 can generate graph data for generating an appropriate graph.

In addition, in the generation apparatus 100 according to the embodiment, the second generation unit extracts output edges of the third number from among output edges having each node as a start point, targeted for each of a plurality of nodes included in the target graph, and then adds the extracted output edges to the second graph.

In this manner, by adding the output edge included in the target graph, with no change, to the second graph, the generation apparatus 100 according to the embodiment can generate the second graph entirely utilizing the information of the edge of the target graph. Accordingly, the generation apparatus 100 can generate graph data for generating an appropriate graph.

In addition, in the generation apparatus 100 according to the embodiment, the second generation unit extracts output edges of the third number, being smaller than the second number, from among output edges having each node included in the target graph as a start point.

In this manner, by setting the number of output edges to be added from the target graph, with no change, to the second graph smaller than the number of edges to be added to the second graph after inverting the direction from the first graph, the generation apparatus 100 according to the embodiment can generate the second graph entirely utilizing the information of the edge of the target graph while suppressing the increase in the number of output edges. Accordingly, the generation apparatus 100 can generate graph data for generating an appropriate graph.

In addition, in the generation apparatus 100 according to the embodiment, the first generation unit extracts output edges of a fourth number from among output edges having each node as a start point, targeted for each of a plurality of nodes included in the target graph, and then adds the extracted output edges to the first graph.

In this manner, by adding the output edge included in the target graph, with no change, to the first graph, the generation apparatus 100 according to the embodiment can generate the first graph entirely utilizing the information of the edge of the target graph. Accordingly, the generation apparatus 100 can generate graph data for generating an appropriate graph.

In addition, in the generation apparatus 100 according to the embodiment, the first generation unit extracts output edges of the fourth number, being smaller than the first number, from among output edges having each node included in the target graph as a start point.

In this manner, by setting the number of output edges to be added from the target graph, with no change, to the first graph smaller than the number of edges to be added to the first graph after inverting the direction from the target graph, the generation apparatus 100 according to the embodiment can generate the first graph entirely utilizing the information of the edge of the target graph while suppressing the increase in the number of output edges. Accordingly, the generation apparatus 100 can generate graph data for generating an appropriate graph.

In addition, in the generation apparatus 100 according to the embodiment, the second generation unit extracts output edges of the fifth number from among output edges having each node as a start point, targeted for each of a plurality of nodes included in the first graph, and then adds the extracted output edges to the second graph.

In this manner, by adding the output edge included in the first graph, with no change, to the second graph, the generation apparatus 100 according to the embodiment can generate the second graph entirely utilizing the information of the edge of the first graph. Accordingly, the generation apparatus 100 can generate graph data for generating an appropriate graph.

In addition, in the generation apparatus 100 according to the embodiment, the second generation unit extracts output edges of the fifth number, being smaller than the second number, from among output edges having each node included in the first graph as a start point.

In this manner, by setting the number of output edges to be added from the first graph, with no change, to the second graph smaller than the number of edges to be added to the second graph after inverting the direction from the first graph, the generation apparatus 100 according to the embodiment can generate the second graph entirely utilizing the information of the edge of the first graph while suppressing the increase in the number of output edges. Accordingly, the generation apparatus 100 can generate graph data for generating an appropriate graph.

In addition, in the generation apparatus 100 according to the embodiment, the first generation unit extracts output edges of the first number in order from a shorter edge, from among output edges having each node included in the target graph as a start point.

In this manner, the generation apparatus 100 according to the embodiment extracts the output edges from the shorter one of the output edges having each node included in the target graph as a start point, thereby generating the first graph preferentially using the information of the short edge among the edges of the target graph. Accordingly, the generation apparatus 100 can generate graph data for generating an appropriate graph.

In addition, in the generation apparatus 100 according to the embodiment, the second generation unit extracts output edges of the second number in order from a shorter edge, from among output edges having each node included in the first graph as a start point.

In this manner, the generation apparatus 100 according to the embodiment extracts the output edges from the shorter one of the output edges having each node included in the first graph as a start point, thereby generating the second graph preferentially using the information of the short edge among the edges of the first graph. Accordingly, the generation apparatus 100 can generate graph data for generating an appropriate graph.

Furthermore, in the generation apparatus 100 according to the embodiment, the acquisition unit acquires a target graph being a neighbor graph. The first generation unit extracts output edges of the first number from among output edges having each node as a start point, targeted for each of a plurality of nodes included in the neighbor graph, and generates the first graph having the plurality of nodes being linked by an edge obtained by inverting the direction of the extracted output edge.

In this manner, the generation apparatus 100 according to the embodiment generates the second graph targeted for the existing neighbor graph, making it possible to generate the second graph in which the edge of the existing neighbor graph has been adjusted. Accordingly, the generation apparatus 100 can generate graph data for generating an appropriate graph.

### 7. Hardware Configuration

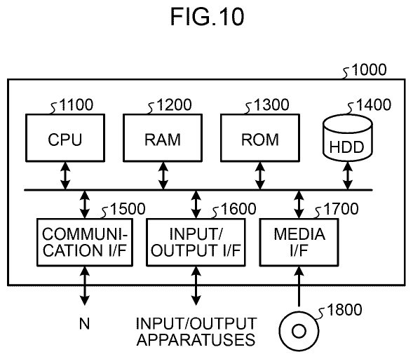

The generation apparatus 100 according to the embodiment described above is implemented by a computer 1000 having a configuration as illustrated in FIG. 10, for example. FIG. 10 is a hardware configuration diagram illustrating an example of the computer that implements functions of the generation apparatus. The computer 1000 includes a CPU 1100, RAM 1200, read only memory (ROM) 1300, a hard disk drive (HDD) 1400, a communication interface (I/F) 1500, an input/output interface (I/F) 1600, and a media interface (I/F) 1700.

The CPU 1100 operates based on a program stored in the ROM 1300 or the HDD 1400, and controls each unit. The ROM 1300 stores a boot program executed by the CPU 1100 when the computer 1000 is activated, a program depending on hardware of the computer 1000, and the like.

The HDD 1400 stores a program executed by the CPU 1100, data used by the program, and the like. The communication interface 1500 receives data from another apparatus via the network N, transmits the received data to the CPU 1100, and transmits data generated by the CPU 1100 to another apparatus via the network N.

The CPU 1100 controls an output apparatus such as a display or a printer and an input apparatus such as a keyboard or a mouse via the input/output interface 1600. The CPU 1100 acquires data from the input apparatus via the input/output interface 1600. In addition, the CPU 1100 outputs the generated data to the output apparatus via the input/output interface 1600.

The media interface 1700 reads a program or data stored in a recording medium 1800 and provides the program or data to the CPU 1100 via the RAM 1200. The CPU 1100 loads the program from the recording medium 1800 onto the RAM 1200 via the media interface 1700, and executes the loaded program. Examples of the recording medium 1800 include an optical recording medium such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the generation apparatus 100 according to the embodiment, the CPU 1100 of the computer 1000 executes the program loaded on the RAM 1200 to implement the function of the control unit 130. The CPU 1100 of the computer 1000 executes these programs read from the recording medium 1800, may acquire these programs from another apparatus via the network N, as another example.

Some of the embodiments of the present application have been described in detail with reference to the drawings as above. However, these are merely examples, and the present invention can be implemented in other forms subjected to various modifications and improvements based on the knowledge of those skilled in the art, including the aspects described in the disclosure of the invention.

### 8. Others

Among the processes described in the above embodiments, all or a part of the processes described as being automatically performed can be manually performed, or all or a part of the processes described as being manually performed can be automatically performed by a known method. In addition, the processing procedure, specific name, and information including various data and parameters illustrated in the document and the drawings can be flexibly changed unless otherwise specified. For example, the various types of information illustrated in each figure are not limited to the illustrated information.

In addition, individual components of each apparatus illustrated in the drawings are functionally conceptual, and are not necessarily to be physically configured as illustrated in the drawings. That is, specific forms of distribution and integration of each apparatus are not limited to the illustrated forms, and all or a part thereof can be functionally or physically distributed and integrated in any unit according to various loads, usage conditions, and the like.

In addition, each processing described in each embodiment described above can be appropriately combined with each other within a range not causing conflict of processing.

In addition, the “Portion (section, module, unit)” described above can be rephrased as other terms such as “means” and “circuit”. For example, the acquisition unit can be replaced with an acquisition unit or an acquisition circuit.

According to one aspect of the embodiment, it is possible to generate an appropriate graph.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A generation apparatus comprising:
an acquisition unit that acquires a target graph, being a graph in which a plurality of nodes is linked by edges, the plurality of nodes being nodes corresponding to a plurality of objects being targets of data search;
a first generation unit that extracts output edges of a first number from among output edges having each of the nodes as a start point, targeted for each of the plurality of nodes included in the target graph, and then generates a first graph in which the plurality of nodes is linked by an edge obtained by inverting a direction of the extracted output edge; and
a second generation unit that extracts output edges of a second number from among output edges having each of the nodes as a start point, targeted for each of the plurality of nodes included in the first graph, and then generates a second graph in which the plurality of nodes is linked by an edge obtained by inverting a direction of the extracted output edge.

2. The generation apparatus according to claim 1,
wherein the second generation unit extracts output edges of a third number from among output edges having each node as a start point, targeted for each of the plurality of nodes included in the target graph, and then adds the extracted output edges to the second graph.

3. The generation apparatus according to claim 2,
wherein the second generation unit extracts output edges of the third number, being smaller than the second number, from among output edges having each node included in the target graph as a start point.

4. The generation apparatus according to claim 1,
wherein the first generation unit extracts output edges of a fourth number from among output edges having each node as a start point, targeted for each of the plurality of nodes included in the target graph, and then adds the extracted output edges to the first graph.

5. The generation apparatus according to claim 4,
wherein the first generation unit extracts output edges of the fourth number, being smaller than the first number, from among output edges having each node included in the target graph as a start point.

6. The generation apparatus according to claim 1,
wherein the second generation unit extracts output edges of a fifth number from among output edges having each node as a start point, targeted for each of the plurality of nodes included in the first graph, and then adds the extracted output edges to the second graph.

7. The generation apparatus according to claim 6,
wherein the second generation unit extracts output edges of the fifth number, being smaller than the second number, from among output edges having each node included in the first graph as a start point.

8. The generation apparatus according to claim 1,
wherein the first generation unit extracts output edges of the first number in order from a shorter edge, from among output edges having each node included in the target graph as a start point.

9. The generation apparatus according to claim 1,
wherein the second generation unit extracts output edges of the second number in order from a shorter edge, from among output edges having each node included in the first graph as a start point.

10. The generation apparatus according to claim 1,
wherein the acquisition unit acquires the target graph being a neighbor graph, and
the first generation unit extracts output edges of the first number from among output edges having each node as a start point, targeted for each of the plurality of nodes included in the neighbor graph, and generates the first graph having the plurality of nodes being linked by an edge obtained by inverting the direction of the extracted output edge.

11. A generation method to be executed by a computer, the method comprising:
an acquisition step of acquiring a target graph, being a graph in which a plurality of nodes is linked by edges, the plurality of nodes being nodes corresponding to a plurality of objects being targets of data search;
a first generation step of extracting output edges of a first number from among output edges having each of the nodes as a start point, targeted for each of the plurality of nodes included in the target graph, and then generating a first graph in which the plurality of nodes is linked by an edge obtained by inverting a direction of the extracted output edge; and
a second generation step of extracting output edges of a second number from among output edges having each of the nodes as a start point, targeted for each of the plurality of nodes included in the first graph, and then generating a second graph in which the plurality of nodes is linked by an edge obtained by inverting a direction of the extracted output edge.

12. A non-transitory computer-readable recording medium having stored therein a generation program causing a computer to execute:
an acquisition procedure of acquiring a target graph, being a graph in which a plurality of nodes is linked by edges, the plurality of nodes being nodes corresponding to a plurality of objects being targets of data search;
a first generation procedure of extracting output edges of a first number from among output edges having each of the nodes as a start point, targeted for each of the plurality of nodes included in the target graph, and then generating a first graph in which the plurality of nodes is linked by an edge obtained by inverting a direction of the extracted output edge; and
a second generation procedure of extracting output edges of a second number from among output edges having each of the nodes as a start point, targeted for each of the plurality of nodes included in the first graph, and then generating a second graph in which the plurality of nodes is linked by an edge obtained by inverting a direction of the extracted output edge.
